(19) United States
(12) Patent Application Publication
(10) Pub. No.: US 2016/0271020 A1
(43) Pub. Date: Sep. 22, 2016

(54) Pacifier Holder

(71) Applicants: Harry Coffey, Beverly, MA (US); Alexander H. Fish, Danvers, MA (US); Mary Fish, Danvers, MA (US)

(72) Inventors: Harry Coffey, Beverly, MA (US); Alexander H. Fish, Danvers, MA (US); Mary Fish, Danvers, MA (US)

(21) Appl. No.: 14/662,901

(22) Filed: Mar. 19, 2015

(51) Int. Cl. A61J 17/00

(52) U.S. Cl. CPC A61J 17/00

(57) ABSTRACT

Disclosed is a pacifier that includes a nipple with a bulb and a holding site. A nipple holding member has a nipple holding site constructed to hold the nipple at its holding site and has left and right temple interface sites. The pacifier also includes a left temple with a left member spanning rigidly from the left temple holding site of the nipple holding member to the upper end of a downward facing left temple tip, and a right temple with a right member spanning rigidly from the right temple holding site of the nipple holding member to the upper end of a downward facing right temple tip. Also disclosed is a method of providing access to a pacifier by an individual that includes providing a pacifier bulb, providing a structure to hold the pacifier bulb relative to an anatomical feature of the individual, selecting a dimension of the structure to hold the pacifier at a position that is proximate but spaced apart from an ordinary use position the individual's mouth, and positioning the bulb and structure relative to the individual in concert with the anatomical feature at a position that allows the individual to elect to reach the pacifier with his or her mouth.

### FIELD OF THE INVENTION

This invention relates to pacifier holders and related methods.

### BACKGROUND OF THE INVENTION

Pacifiers are well known for soothing infants and small children. Two general types of pacifier holders are also known. One kind holds the pacifier to a garment or other holding site, typically with a clip and lanyard, so that it does not tend to get lost or fall on the ground. Another type is designed to keep the pacifier in a child's mouth, such as with straps.

### SUMMARY OF THE INVENTION

In one general aspect, the invention features a pacifier that includes a nipple with a bulb and a holding site. A nipple holding member has a nipple holding site constructed to hold the nipple at its holding site and has left and right temple interface sites. The pacifier also includes a left temple with a left member spanning rigidly from the left temple holding site of the nipple holding member to the upper end of a downward facing left temple tip, and a right temple with a right member spanning rigidly from the right temple holding site of the nipple holding member to the upper end of a downward facing right temple tip.

In preferred embodiments, the pacifier can further include a fastening mechanism operative to removably hold the attachment site of the nipple to the nipple holding site of the nipple holder. The fastening mechanism can include at least one threaded hole defined by the nipple at its holding site. The fastening mechanism can include at least one threaded fastener sized to mate with the threaded hole defined by the nipple at its holding site. The nipple holding member can include at least one through-hole sized to allow the threaded fastener to pass through and thereby reach the threaded hole defined by the nipple. The fastening mechanism can include bendable wire. The left and right temples can be made of a material that exhibits sufficient plasticity to allow them to be reshaped by hand. The nipple holding member and the left and right temples can be part of a unitary structure. The pacifier can further include a left hinge attached between the left temple interface site and the left temple member opposite the left temple tip and a right hinge attached between the left temple interface site and the left temple member opposite the left temple tip.

In another general aspect, the invention features a method of providing access to a pacifier by an individual that includes providing a pacifier bulb, providing a structure to hold the pacifier bulb relative to an anatomical feature of the individual, selecting a dimension of the structure to hold the pacifier at a position that is proximate but spaced apart from an ordinary use position the individual's mouth, and positioning the bulb and structure relative to the individual in concert with the anatomical feature at a position that allows the individual to elect to reach the pacifier with his or her mouth.

In preferred embodiments the step of positioning can position the structure and bulb in a manner that allows it to slide generally back and forth with respect to the individual's mouth. The method can further include the step of replacing the bulb held by the structure with a new bulb. The steps of providing a bulb and structure, adjusting, and positioning can be performed for a patient in a health care setting. The step of providing a structure to hold the pacifier bulb relative to an anatomical feature of the individual can provide a structure to hold the structure relative to the individual's ears. The step of providing can provide a structure that includes an adjustment mechanism, with the step of selecting a dimension including adjusting the structure to hold the pacifier at a position that is proximate but spaced apart from an ordinary use position the individual's mouth.

In a further general aspect, the invention features a pacifier that includes a pacifier bulb, means for holding the pacifier bulb relative to an anatomical feature of an individual, and means for positioning the bulb and structure relative to the individual in concert with the anatomical feature at a position that allows the individual to elect to reach the pacifier with his or her mouth.

Pacifier holders according to the invention can allow individuals selective easy access to a pacifier. Because the child can let the pacifier go some of the time, pacifier holders according to the invention can reliably provide a child with comfort when it is wanted, but allow him or her to be free of it when it is not. Such holders are believed to be particularly well suited to young children who are ill, injured, or in long term care situations.

### BRIEF DESCRIPTION OF THE DRAWING

FIG. 1 is a side view of a first embodiment of a pacifier holder according to the invention, and

FIG. 2 is a perspective view of a second embodiment of a pacifier holder according to the invention.

### DETAILED DESCRIPTION OF AN ILLUSTRATIVE EMBODIMENT

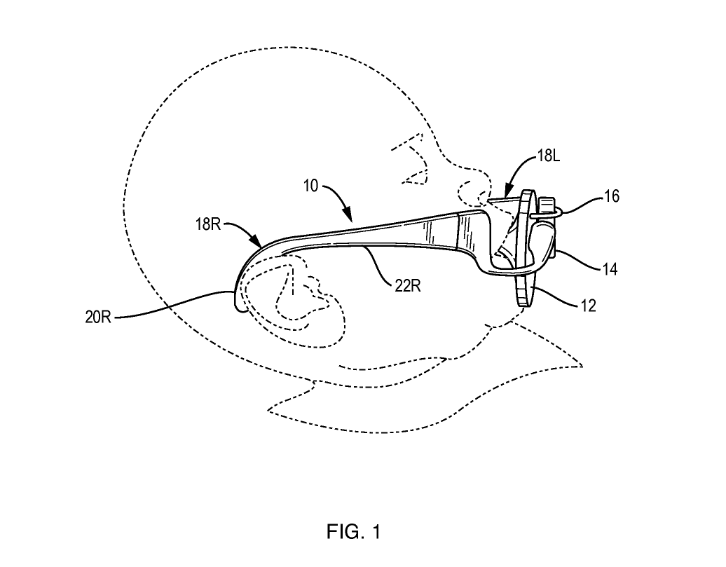

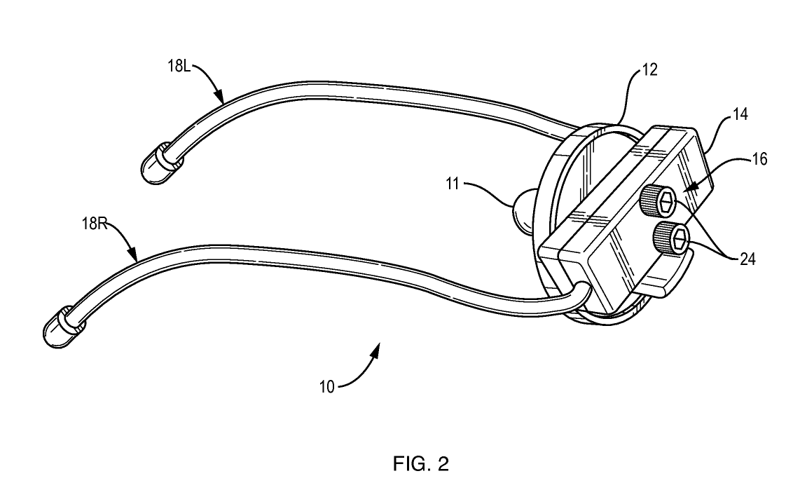

Referring to FIG. 1, an illustrative pacifier holder 10 according to the invention includes a nipple 12 and a nipple holding member 14 that connects it to left and right temples 18L, 18R. It preferably also includes a fastening mechanism 16 that removably holds the nipple to the nipple holding member so it can be replaced. This mechanism can include bendable wire (FIG. 1), one or more screw-based fasteners (FIG. 2), or a variety of other types of fasteners, such as hook-and-loop fasteners, elastics, snaps, clips, or hooks.

The left and right temples each include a downward facing temple tip 20L, 20R and a temple member 22L, 22R that spans from its tip to the nipple holding member 14. The temple members exhibit structural rigidity although they can also exhibit some resilience so that they are comfortable and tend to bend rather than break. The temples can be made of one or more of a number of materials, from metals to plastics and even natural materials such as laminates or wood. In this embodiment, the temples are made of plastic.

In operation, the left and right temples 18L, 18R of the pacifier holder 10 are placed over the medial top portion of the outer projecting portion of the individual's ear (auricle). When they are in place, the temples are designed to hold the pacifier bulb loosely at somewhat of a distance from the individual's mouth. This allows the individual to elect to hold the nipple's bulb (11) in his or her mouth or let the pacifier fall out. When not in use, the pacifier is held in a position that allows the individual to retrieve it by moving his or her mouth and/or by pushing it with his or her hand. It may rest against the individual's chin, his or her chest, or any other suitable location. Preferably, the temples should be sufficiently long to allow the pacifier bulb to slide forward and fall fully out of the individual's mouth in front of his or her mouth.

Referring to FIG. 2, a second illustrative pacifier holder 10 according to the invention includes a nipple 12 and a nipple holding member 14 that connects it to left and right temples 18L, 18R. It preferably also includes a fastening mechanism 16 that removably holds the nipple to the nipple holding member so it can be replaced. In this embodiment, the fastening mechanism includes two screw-based fasteners 24 that pass through holes in the nipple holding member and screw into threaded holes in the nipple to hold the nipple to the nipple holding member.

This embodiment also includes adjustable temples 18L, 18R. These adjustable temples let the pacifier holder be bent so that it holds it in a position that allows the individual to use the pacifier or let it fall out of his or her mouth. In this embodiment, the temples are made of plastic-coated bendable wire. Other suitable adjustment mechanisms are also possible, such as a telescoping mechanism or a two-part temple mechanism, in which two parts of a temple are held relative to each other by a fastening mechanism such as a pair of hook-and-loop strips.

### EXAMPLES

The embodiment of the pacifier of FIG. 1 was provided to a child named Theodore Royce Fish for an eight-month period. Shortly after the beginning of the trial period, he was diagnosed with a condition that impaired his strength. He continued to use it after the diagnosis and, based on observing him over that period, it is believed that the pacifier holder provided him with some optional relief during his illness and that this had a positive impact on his life. Although Theodore ultimately died of his condition a little after his first birthday, it is hoped that embodiments of the invention presented in this application can help the lives of similarly situated individuals.

The embodiment of FIG. 2 has been under test with a healthy child for over a month, and she appears to have taken well to it. She quickly learned that she can select to use it or not. And after observing her on a regular basis, she clearly appears to enjoy having selective access to it.

The present invention has now been described in connection with a number of specific embodiments thereof. However, numerous modifications which are contemplated as falling within the scope of the present invention should now be apparent to those skilled in the art. For example, while the temples are shown attached to the nipple holding member, they could also be hinged or removable, and while temples are shown that hold the pacifier relative to the individual's ears, the holder could also position the pacifier relative to other anatomical features, such as the back of the individual's head. Therefore, it is intended that the scope of the present invention be limited only by the scope of the claims appended hereto. In addition, the order of presentation of the claims should not be construed to limit the scope of any particular term in the claims.

What is claimed is:

1. A pacifier, including:
a nipple including a bulb and a holding site,
a nipple holding member having a nipple holding site constructed to hold the nipple at its holding site and having left and right temple interface sites,
a left temple including:
a downward facing left temple tip having upper and lower ends, and
a left member spanning rigidly from the left temple holding site of the nipple holding member to the upper end of the left temple tip,
a right temple including:
a downward facing right temple tip having upper and lower ends, and
a right member spanning rigidly from the right temple holding site of the nipple holding member to the upper end of the right temple tip.

2. The apparatus of claim 1 further including a fastening mechanism operative to removably hold the attachment site of the nipple to the nipple holding site of the nipple holder.

3. The apparatus of claim 2 wherein the fastening mechanism includes at least one threaded hole defined by the nipple at its holding site.

4. The apparatus of claim 3 wherein the fastening mechanism includes at least one threaded fastener sized to mate with the threaded hole defined by the nipple at its holding site.

5. The apparatus of claim 4 wherein the nipple holding member includes at least one through-hole sized to allow the threaded fastener to pass through and thereby reach the threaded hole defined by the nipple.

6. The apparatus of claim 2 wherein the fastening mechanism includes bendable wire.

7. The apparatus of claim 1 wherein the left and right temples are made of a material that exhibits sufficient plasticity to allow them to be reshaped by hand.

8. The apparatus of claim 1 wherein the nipple holding member and the left and right temples are part of a unitary structure.

9. The apparatus of claim 1 further including a left hinge attached between the left temple interface site and the left temple member opposite the left temple tip and a right hinge attached between the left temple interface site and the left temple member opposite the left temple tip.

10. A method of providing access to a pacifier by an individual, including:
providing a pacifier bulb,
providing a structure to hold the pacifier bulb relative to an anatomical feature of the individual,
selecting a dimension of the structure to hold the pacifier at a position that is proximate but spaced apart from an ordinary use position the individual's mouth, and
positioning the bulb and structure relative to the individual in concert with the anatomical feature at a position that allows the individual to elect to reach the pacifier with his or her mouth.

11. The method of claim 10 wherein the step of positioning positions the structure and bulb in a manner that allows it to slide generally back and forth with respect to the individual's mouth.

12. The method of claim 10 further including the step of replacing the bulb held by the structure with a new bulb.

13. The method of claim 10 wherein the steps of providing a bulb and structure, adjusting, and positioning are performed for a patient in a health care setting.

14. The method of claim 10 wherein the step of providing a structure to hold the pacifier bulb relative to an anatomical feature of the individual provides a structure to hold the structure relative to the individual's ears.

15. The method of claim 10 wherein the step of providing provides a structure that includes an adjustment mechanism and wherein the step of selecting a dimension includes adjusting the structure to hold the pacifier at a position that is proximate but spaced apart from an ordinary use position the individual's mouth.

16. A pacifier, including:
a pacifier bulb,
means for holding the pacifier bulb relative to an anatomical feature of an individual, and
means for positioning the bulb and structure relative to the individual in concert with the anatomical feature at a position that allows the individual to elect to reach the pacifier with his or her mouth.
